(19) United States
(12) Patent Application Publication
(10) Pub. No.: US 2025/0053894 A1
(43) Pub. Date: Feb. 13, 2025

(54) SYSTEMS AND METHODS FOR GENERATING A SKILLS GRAPH

(71) Applicant: Cobrainer GmbH, München (DE)

(72) Inventors: Martin KIECHLE, Blaustein (DE); Sarath Kumar KONDREDDI, München (DE)

(21) Appl. No.: 18/596,465

(22) Filed: Mar. 5, 2024

(30) Foreign Application Priority Data
Aug. 11, 2023 (IE) S2023/0333

(51) Int. Cl. G06Q 10/0631

(52) U.S. Cl. CPC G06Q 10/063112; G06F 40/30; G06Q 10/0639

(57) ABSTRACT

The present disclosure provides computer-implemented systems and methods for building a skills graph, as well as related systems and methods for generating recommendations, determining gap skills, and other outputs based on a skills graph.

### CROSS-REFERENCE TO RELATED APPLICATION

This application claims the benefit of Irish Patent Application No. S2023/0333, filed on Aug. 11, 2023, the entire disclosure of which is incorporated herein by reference for all purposes.

### TECHNICAL FIELD

The present disclosure relates to the field of computer science. In particular, the present disclosure relates to computer-implemented systems for inventorying and evaluating skill sets associated with employees, job applicants, and other entities, using a graph data structure, and methods of use related thereto.

### BACKGROUND

The accurate analysis of a person's individual skills and qualifications are a key component of successful recruiting and upskilling processes. For example, in order to find a suitable job for a person, one may generate a skill profile for the individual, which indicates the person's qualifications, soft skills, language skills, etc. On the other side, job descriptions also typically formulate requirements of a suitable applicant in terms of such skills. If the person's skill profile matches all requirements of the job description, the person can be considered a suitable applicant, or, vice versa, the job is a relevant option for the person. However, the person may still be relevant for the job if the person's skill profile matches the job description only approximately, since the person may be able to easily obtain the missing skill(s) (e.g., by attending sufficient training). As trainings ensure that persons can acquire new skills, a skill profile can be associated with every training. It is therefore essential for modern companies to have an insight into skill profiles of persons (for example, employees and external applicants) as well as skill profiles of other entities (for example, job descriptions, trainings, projects etc.).

Often, textual documents exists which provide information about the skills of a person and other entities. For example, the curiculum vitae (“CV”) of an applicant typically contains information about the education, soft-skills, and particular strengths of the person. Also, job descriptions typically provide minimum requirements with respect to educational degree, professional experience, and individual requirements for a suitable applicant.

However, several problems exist when processing those textual documents manually or using traditional methods. One particular challenge is the high degree of ambiguity in natural language. For example, syntactically different terms need to be related to the same semantic concept, for example, “Autonomous driving” and “Self-driving.” Moreover, in other situations, a single term may need to be related to different semantic concepts, e.g., “NLP” as an abbreviation for “non-linear programming” and “natural language processing.” Another challenge is the variety of possible input sources (text documents, job portals, online databases, etc.) to be processed, each of them providing information on skills in different formats.

### BRIEF SUMMARY OF THE DISCLOSURE

The present disclosure provides systems and methods for managing skills information, which are more efficient and/or more accurate than traditional processing methods, providing various advantages and benefits compared to prior techniques. In particular, provided herein are computer-implemented systems and methods for building a skills graph, as well as related systems and methods for generating recommendations, determining gap skills, and other outputs based on a skills graph. These systems, as well as related methods of use and computer-readable media, shall be described in further detail herein and/or illustrated in the accompanying drawings.

In a first general aspect, the disclosure provides a computer-implemented method for generating a skills graph, comprising: a) processing, by a computer, at least one input document to generate a list of candidate skill topics; b) generating, by the computer, a list of skill topics based on the list of candidate skill topics; c) generating, by the computer, a skill relation score for each pair of skill topics; d) generating, by the computer, a plurality of skill labels associated with at least some of the skill topics, using the at least one input document and/or a knowledge database stored in a memory accessible to the computer; e) generating, by the computer, a label association score for each skill label; and f) generating, by the computer, a skills graph comprising (e.g., at least 10,000) nodes and/or weighted edges, by: i) defining a skill topic node for each skill topic; ii) defining a skill label node for each skill label; iii) defining a weighted edge between each pair of skill topics, wherein the weight of the edge corresponds to the skill relation score; and iv) defining a weighted edge between each pair of skill topic and skill label, wherein the weight of the edge corresponds to the label association score.

In some aspects, the input document is a textual data source and step a) comprises: i) analyzing a grammatical structure of the input document; and/or ii) extracting words, optionally nouns and/or verbs, and/or sequences of words, from the input document to generate the list of candidate skill topics.

In some aspects, the method further comprises the following step between steps a) and b): filtering the list of candidate skill topics, wherein the filtering comprises matching each candidate skill topic against a knowledge database, optionally wherein the knowledge database comprises a public encyclopedia.

In some aspects, step b) comprises the following steps: i) classifying, each candidate skill topic into one of a plurality of classes, comprising at least one skill-class and at least one non-skill class, optionally wherein the classifying is performed by a large language model; and ii) removing each candidate skill topic that is classified into a non-skill class from the list of candidate skill topics.

In some aspects, the method further comprises the following steps between steps b) and c): i) identifying synonymous skill topics, optionally by checking whether a pair of skill topics relates to the same document of a knowledge database; and ii) for each skill topic, remove corresponding synonymous skill topics from the list of skill topics.

In some aspects, step c) comprises the following steps: i) generating a vector representation in a high-dimensional vector space for each skill topic; and ii) computing a metric in the vector space based on context information associated with each pair of skill topics; wherein the skill relation score is generated based on the value of the metric for the pair of skill topics.

In some aspects, step d) comprises at least one of the following: i) extracting phrases from the at least one input document; ii) manipulating phrases extracted from the input document, optionally by removing prefixes and/or suffixes; and/or iii) generating or extracting an abbreviation corresponding to a skill topic, optionally using a knowledge database.

In some aspects, step e) comprises: associating a probability distribution to the skill label, wherein the probability distribution is defined over all skill topics associated with the skill label and may be obtained from a knowledge database, optionally wherein the knowledge database comprises a public encyclopedia; and the label association score is calculated by the marginal probability of the skill label over the probability distribution of the skill label.

In some aspects, the method further comprises the following steps after step f): i) removing edges from the skills graph whose weight is less than a threshold value; and/or ii) removing isolated nodes, optionally skill label nodes, from the skills graph.

In a second general aspect, the disclosure provides a computer-implemented method for building a skill profile of an entity, optionally wherein the entity comprises a user, a job role, a job posting, a project, a work assignment, or a training, wherein the method comprises: a) processing, by a computer, at least one input document to generate a plurality of phrases, wherein the at least one input document contains information about the entity; b) generating a skills graph (e.g., comprising at least 10,000 nodes and/or weighted edges), by the computer, optionally according to any of the methods descried herein; c) matching, by the computer, at least some of the phrases to one or more skill labels from the skills graph; d) for each skill label that is matched to a phrase, identifying at least one skill topic in the skills graph, optionally based on the label association score, and adding the skill topic to the skill profile of the entity; and e) generating, by the computer, a relevance score for each skill topic in the skill profile based on the at least one input document.

In some aspects, step a) comprises at least one of the following: a) extracting phrases, optionally nouns and/or verbs, from the at least one input document; and/or b) applying a classification procedure on the extracted phrases for classifying the phrases into one of a plurality of classes, comprising at least one skill-class and at least one non-skill class.

In some aspects, step c) comprises applying an algorithm for fuzzy string matching.

In some aspects, in step e), the relevance score for each skill topic is computed based on at least one of the following: the i) number of occurrences of the corresponding phrase in the at least one input document; ii) a position of the corresponding phrase in the at least one input document; and/or iii) a skill relation score of a second skill topic identified in the at least one input document.

In some aspects, the method further comprises: loading a template associated with the at least one input document, wherein the template defines a section weight for each section of the at least one input document; and wherein in step e), the relevance score for each skill topic is generated further based on the section weight of the section that comprises the phrase corresponding to the skill topic.

In some aspects, the method further comprises: assigning each skill topic from the skill profile to one of multiple levels according to the relevance score associated with the skill topic.

In some aspects, the method further comprises: i) receiving a user input specifying at least one level for a skill topic; and ii) updating the assignment of skill topics to levels according to the user input.

In a third general aspect, the disclosure provides a computer-implemented method for determining at least one target entity for a source entity, comprising: a) generating a skills graph (e.g., comprising at least 10,000 nodes and/or weighted edges), optionally according to the method of claim 1; b) generating a skill profile of the source entity, optionally according to any of the methods described herein; c) generating a skill profile for at least one target entity candidate, optionally according to any of the methods described herein; d) for each source skill from the skill profile of the source entity: i) performing an iterated neighborhood search in the skills graph, starting from the source skill, until at least one target skill is identified, wherein a target skill is a skill topic associated with the skill profile of a target entity candidate; and ii) generating a weighted score for the at least one target skill; e) generating a total relevance score for each target entity candidate, based on relevance scores of skill topics from the skill profile of the target entity candidate; and f) providing a recommendation list comprising each target entity candidate together with its total relevance score.

In some aspects, the weighted score for the at least one target skill is a linear combination of at least one of the following: a weight of the source skill according to the skill profile of the source entity; a weight of the target skill according to the skill profile of the target entity candidate; and/or the skill relation scores of any pair of skill topics that is adjacent in the skills graph and is located on a path between the source skill and the target skill; wherein the weight of the source skill depends on a level of the source skill and on the relevance score of the source skill in the skill profile of the source entity, and the weight of the target skill depends on a level of the target skill and on the relevance score of the target skill in the skill profile of the target entity.

In some aspects, the iterated neighborhood search follows a breadth-first-search principle.

In some aspects, the iterated neighborhood search is performed until a predetermined number of different target entity candidates are covered.

In some aspects, the method further comprises: receiving user input comprising instructions for adapting the recommendation list, optionally a set of target entities to be deleted and/or an updated order of target entities; and adapting the recommendation list according to the user input.

In some aspects, the method further comprises: receiving user input indicative of a favorites list comprising target entities from the recommendation list; and storing the favorites list in a user profile.

In a fourth general aspect, the disclosure provides a computer-implemented method for determining gap skills for a source entity with respect to a target entity, wherein the method comprises: a) generating a skills graph, optionally according to any of the methods described herein; b) generating respective skill profiles of the source entity and the target entity, optionally according to any of the methods described herein; c) determining a list of gap skills, based on a difference between the skill profile of the target entity and the skill profile of the source entity; d) for each gap skill from the list of gap skills, i) checking whether there exists a proxy skill topic in the skill profile of the source entity such that a relation score of the gap skill and the proxy skill topic exceeds a threshold value, and ii) removing the gap skill from the list of gap skills if the proxy skill topic exists; and e) providing the list of gap skills.

In some aspects, the list of gap skills is provided in a sorted order in accordance with levels of the corresponding skill topics in the skill profile of the target entity.

In some aspects, the method further comprises the following steps: i) identifying at least one training based on the list of gap skills; and ii) providing a list of trainings to a user, the list comprising the at least one identified training, in a sorted order; wherein the sorted order is sorted in accordance with levels of the corresponding skill topics in the skill profile of the target entity.

In a fifth general aspect, the disclosure provides a computer-implemented method for mapping organizational competencies, wherein the method comprises: a) generating a skills graph, optionally according to any of the methods described herein; b) processing at least one input list of competencies associated with an organization, optionally by processing at least one job description associated with the organization; c) for each competency, identifying associated skill topics from the skills graph to generate a competency model; and d) for each competency and one or more source entities, determining a competency gap based on the competency model and corresponding skill profiles of the one or more source entities, optionally wherein each source entity comprises a person, a job, project, or a work assignment.

In some aspects, step d) comprises: determining one or more gap skills, optionally using any of the methods described herein, for the one or more source entities with respect to the competency model as a target entity; wherein the competency gap includes at least some of the determined gap skills.

In some aspects, the method further comprises identifying at least one training or a series of trainings, based on the one or more gap skills.

In a sixth general aspect, the disclosure provides a computer-implemented method for generating descriptions for an entity, optionally wherein the entity comprises an organizational job role, a job posting, a project, or a work assignment, wherein the method comprises: a) generating a skills graph, optionally according to any of the methods described herein; b) training and/or fine-tuning a language model, optionally a large language model, using textual data descriptive of skills, job roles, job postings and/or projects; c) receiving, as a user input, a title for the entity; d) receiving, as a user input, a list of skill topics from the skills graph; e) applying the language model on the title for generating a description, optionally in natural language, about the entity; and f) generating a list of responsibilities and activities for the entity by using template queries on the language model, the template queries comprising the title and the list of skill topics.

In a sixth general aspect, the disclosure provides a computer-readable medium comprising instructions that, when executed by at least one processor, cause the at least one processor to implement any combination of, or all, of the steps of any of the methods described herein.

In a seventh general aspect, the disclosure provides a system capable of performing any combination of, or all, of the steps of any of the methods described herein. In some aspects, the system comprises a storage unit, configured to store a skills graph; an input document interface, configured to process at least one input document, optionally wherein the document comprises a textual input document; a knowledge database interface, configured to provide a connection to a knowledge database, optionally wherein the knowledge database comprises an online encyclopedia; a user interface, configured to receive user input; and a processing unit, configured to perform the method of claim 1 using the storage unit, the input document interface, the knowledge database interface, and the user interface.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### DESCRIPTION OF THE FIGURES

The accompanying drawings illustrate and describe exemplary aspects of the disclosure and are not meant to limit the scope of the invention as defined by the claims.

FIG. 1 illustrates an example of a CV for an individual.

FIG. 2 illustrates a list of candidate skill topics and a list of skill topics.

FIG. 3 illustrates another list of skill topics extracted from a template CV.

FIG. 4 illustrates a skills graph.

FIG. 5 illustrates another skills graph.

FIG. 6 illustrates three skill profiles.

FIG. 7 illustrates another skill profile with scoring and levels.

FIG. 8 illustrates a graph used to generate a recommendation based on a skills graph and skill profiles.

FIG. 9 illustrates a graph used to identify gap skills based on a skills graph and skill profiles.

FIG. 10 illustrates the generation of a description for a job role.

FIG. 11 illustrates a representative system for implementing one of the methods described above.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

### Generation of a Skills Graph

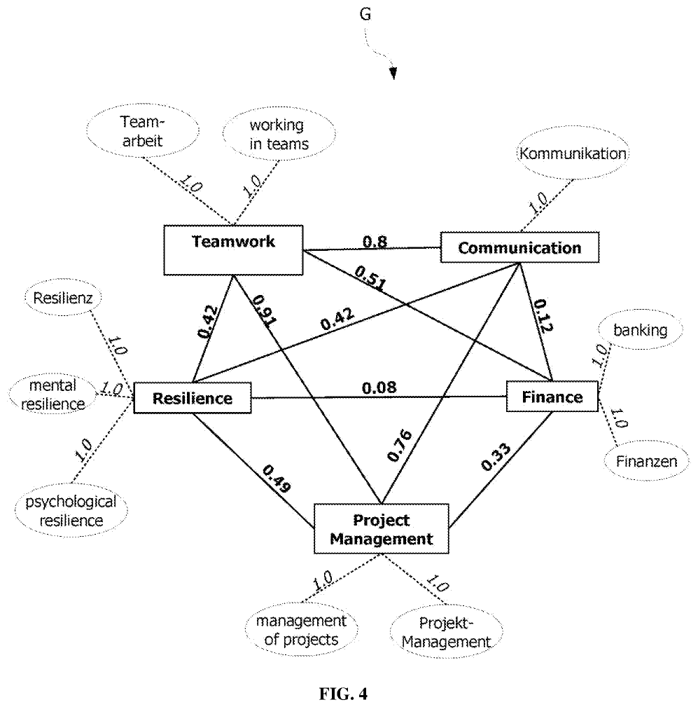

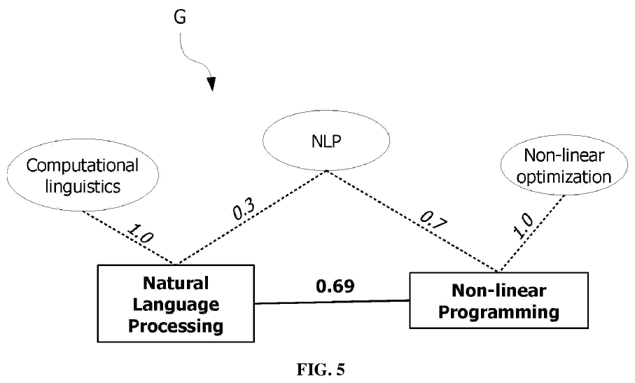

In some aspects, the disclosure provides systems and methods for generating and using a skills graph (e.g., as illustrated by FIG. 4 and FIG. 5). This versatile data structure may be used to represent a highly interconnected network of skills. In some aspects, the skills graph is based on skill topics, wherein each skill topic can be considered the representation of the semantic concept of a skill. However, in some aspects, the skills graph contains not only the skill topics itself, but also supplementary information for each skill and relationships between the skills. The various skills graphs described herein may comprise, e.g., at least 1,000; 5,000; 10,000, 15,000; 20,000; 25,000; 50,000; 75,000; or 100,000 nodes, and/or may also comprise at least 25,000; 50,000; 100,000; 250,000; 500,000; 750,000; or 1,000,000 edges.

In some aspects, a skills graph may be generated based on at least one input document. The at least input document may originate, e.g., from a verified and/or authoritative source, such as from a digital encyclopedia, a dictionary, or a curated dataset. The input document may also be a CV or a job description in textual form.

An exemplary and non-limiting method for generating a skills graph may begin, e.g., at step a), by processing of the at least one input documents to generate a list of candidate skill topics. Candidate skill topics may comprise terms or phrases that potentially constitute a skill topic.

In step b), the method may proceed with the generation of a list of skill topics based on the list of candidate skill topics. In other words, in this step, the list of candidate skill topics may be filtered to remove candidate skill topics that are not identified as skill topics.

In step c), the method may proceed with the generation of a skill relation score for each pair of two skill topics. In some aspects, the skill relation score may indicate a semantic relationship between two skills. The skill relation score may be a normalized numerical value, for example between 0 and 1. For example, the skill topics “automotive engineering” and “mechatronics” may have a skill relation score of 0.75, wherein the skill topics “mechatronics” and “computer vision” may have a skill relation score of 0.12. A non-existing semantic relationship between two skills can be expressed by a skill relation score of 0.

The method may then proceed to step d), with the generation of a plurality of skill labels associated with the skill topics. Skill labels can be considered (alternative) labels or terms that are used to express a skill topic in a natural language. For example, skill labels, can be abbreviations, synonyms, etc., of a term that is used primarily to denote a skill topic. Moreover, skill labels may describe the skill concept using a term from a different language. This way, the skills graph can be built as a multi-language skills graph, in which each skill topics is associated with skill labels that denote the skill topic in one or more additional languages. Skill labels may be generated using the at least one input document and/or a knowledge database, such as a public encyclopedia (e.g., Wikipedia, Wikidata, Stack Exchange, and other similar reputable data sources).

In principle, skill labels may be considered attributes of a skill topic. However, in the skills graph built in step f), skill labels are typically not maintained separately, for example in dedicated lists for each skill topic. Instead, skill labels are represented by dedicated nodes (skill label nodes) in the skills graph, wherein each such node is connected to one or more skill topic nodes. By implementing this data structure, skill labels can be associated with more than one skill topic without the necessity of duplicating the information of the skill label node. The representation of skill labels in the skills graph helps to discover ambiguity from text and effectively resolve it.

In step e), the method may proceed with the generation of a label association score for each skill label. Similar to the skill relation score, the label association score may be a normalized numerical value. The skill relation score of a skill label and a skill topic indicates the weight of the association between the skill label and the skill topic. For example, the skill label “NLP” and the skill topic “natural language processing” may have a label association score of 0.3. At the same time, the same skill label “NLP” and the skill topic “non-linear programming” may have a label association score of 0.7.

Finally, in step f), the skills graph may be created as a graph comprising two types of nodes and two types of weighted edges: a) any skill topic (identified in step b) may be represented by a skill topic node; b) any skill label (identified in step d) may be represented by a skill label node; c) any pair of two skill topics may be connected by a weighted edge, wherein the edge weight corresponds to the skill relation score of the two skill topics; and/or d) any pair of a skill topic and a skill label may be connected by a weighted edge, wherein the edge weight corresponds to the label association score of the skill topic and the skill label (e.g., a numerical value of 0 to 1). Therefore, the skills graph is an essentially complete graph with respect to skill topic nodes. Notably, each skill label is connected with at least one skill topic node and may be shared between multiple skill topics nodes. That is, any skill label has only one skill label node, although it is associated with multiple skill topics. When processing the final skills graph, skill labels can be essentially treated as skill topics.

In some aspects, the input document is a textual data source and step a) comprises: i) analyzing a grammatical structure of the input document; and/or ii) extracting words, such as nouns and/or verbs, and/or sequences of words from the input document to generate the list of candidate skill topics. In some aspects, the list of candidate skill topics may be obtained from classifying each word according to its grammatical category (noun, verb, adjective, etc.) and adding each noun to the list of candidate skill topics. Phrases and/or sequences of words may be extracted from the input document as an alternative or in addition to single words.

In some aspects, it is possible to identify candidate skill topics only based on the grammatical structure of the input document, which can be analyzed algorithmically by a respective classification process.

In some aspects, the method further comprises the following step performed between steps a) and b): filtering the list of candidate skill topics, wherein the filtering comprises matching each candidate skill topic against a knowledge database, in particular provided by a public encyclopedia. For example, in some aspects, the method may iterate trough the list of candidate skill topics and remove a candidate skill topic if no corresponding article in a knowledge database can be identified. The knowledge database may be selected depending on the skill topic candidate to be verified.

The knowledge database can be provided, e.g., by a public encyclopedia (e.g., Wikipedia, Wikidata) or any other online platform (Stack exchange, Google News, ESCO, Espacenet, etc.). To determine the existence of a corresponding article, the method may send a request to an application programming interface of the knowledge database and evaluate the received answer. Additionally, or alternatively, the method may scan a copy of the knowledge database stored on a memory of the system performing the method. This embodiment typically provides an improved list of skill topic candidates, since for relevant skill topic candidates most likely there exists an article in a corresponding knowledge database. Therefore, external knowledge databases may be used to derive a whitelist for candidate skill topics. As a result, the list of candidate skill topics is filtered to a relevant subset at an early stage of the method, which reduces the computational load in the following method steps.

In some aspects, step b) of the method (that is, the generating of the list of the skill topics) comprises the following steps: i) classifying, in particular using a large language model, each candidate skill topic into one of a plurality of classes, comprising at least one skill-class and at least one non-skill class; and ii) removing each candidate skill topic that is classified into a non-skill class from the list of candidate skill topics.

The classification may be performed using a pre-trained large language model (LLM). In particular, the large language model may be pre-trained using public encyclopedic articles on skills and non-skills and be fine-tuned using human labelled data on skills and non-skills. For example, the classifier may be configured to classify the candidate skill topic according to its semantic concept into the skill-class “skill” or one of the non-skill classes “place,” “person,” etc. In some aspects, after classification, only the candidate skill topics classified as “skill” are added to the list of (actual) skill topics.

In some aspects, the method further comprises the following step: comprising the following steps between steps b) and c): i) identifying synonymous skill topics; and ii) for each skill topic, remove corresponding synonymous skill topics from the list of skill topics. As a result, after the removing of synonymous skill topics, only one skill topic with the semantic sense remains in the skills graph.

Synonymous skill topics may be identified by checking whether a pair of skill topics relates to the same document of a knowledge database (e.g., Wikipedia or Wikidata). For this purpose, the method may iterate through the list of candidate skill topics, send a corresponding request to the knowledge database and check whether the resulting article, if existing, is associated with another skill topic from the list. This may be identified by, for example, evaluating the resulting article or detecting a URL redirect.

In some aspects, step c) of the method (that is, the computing of the skill relation score) comprises the following steps: i) generating a vector representation in a high-dimensional vector space for each skill topic; ii) computing a metric in the vector space based on context information associated with each pair of skill topics, and the skill relation score is computed based on the value of the metric for the pair of skill topics. The vector representation of a skill topic may represent or encode a semantic embedding of the skill topic as a vector in an n-dimensional real vector space, indicating its relationships to any other skill topic. In some aspects, the vector representation of a skill topic may be computed by combining the vectors from the layers in a deep neural network which is trained on definitional text about skill topics.

In some aspects, step d) of the method (that is, the generation of the skill labels) comprises at least one of the following steps: i) extracting phrases from the at least one input document; ii) manipulating phrases extracted from the input document, in particular by removing prefixes and/or suffixes; and/or iii) generating or extracting an abbreviation corresponding to a skill topic, in particular using a knowledge database. By implementing one or more of these steps, alternative terms (or strings) can be generated that relate to the same semantic concept (skill topic), although being syntactically different from a primary label of the skill topic. Finally, these alternative terms are added to the skills graph as skill labels. This way, the skills data structure is enhanced further to interrelate the semantic concepts (skill topics) with the plurality of different terms used in natural languages to refer to the skill topics.

In some aspects, step e) (that is, the computing of the label association score) comprises: i) associating a probability distribution to the skill label, wherein the probability distribution is defined over all skill topics associated with the skill label and may be obtained from a knowledge database, in particular a public encyclopedia. The label association score is then calculated by the marginal probability of the skill label over the probability distribution of the skill label.

In some aspects, step e) of the method (that is, the computing of the label association score) comprises the following steps for the skill label and each associated skill topic: i) identifying a first context associated with the skill label, in particular using a knowledge database; ii) identifying a second context associated with the skill topic, in particular using the knowledge database; and iii) computing a distance between the first context and the second context; and the label association score is calculated based on the distance between the first context and the second context. In particular, the distance may be used to define a probability distribution over skill topics associated with the skill label. For example, the knowledge database may be a public online encyclopedia (e.g., Wikipedia) comprising a plurality of interconnected entries. The contexts may be the corresponding entries in the encyclopedia. That is, the first context (=first entry) may be the entry corresponding to the skill label and the second context (=second entry) may be the entry corresponding to the skill topic. The distance between the first context and the second context may be calculated based on i) a number of hops required to reach the second entry starting from the first entry (or vice versa) using the link structure of the encyclopedia, ii) the number of occurrences of the first entry that refer to the second entry in the link structure of the encyclopedia, in proportion to the number of occurrences of the first entry that refer to other entries in the encyclopedia; iii) whether there is a single entry containing the terms for both the skill topic and the skill label; and/or iv) a position distance of terms for both the skill topic and the skill label in a single entry.

At least some of the above aspects may be used to generate a skill relation score, which is associated with a pair of skill topics, in a similar way.

In some aspects, the method comprises further the following steps after step f): i) removing edges from the skills graph whose weight is less than a threshold value; and/or ii) removing isolated nodes, in particular skill label nodes, from the skills graph. For example, the threshold value can be set to 0.01. According to this embodiment, the skills graph is reduced to a graph in which all nodes (that is, skill topics and skill labels) satisfy at least a minimum amount of connectedness. Edges that are weight-wise below the threshold value or nodes that are isolated do not (significantly) determine the outcome of an algorithm processing the skills graph. Therefore, by this embodiment, it can be ensured that algorithms processing the skills graph can process the skills graph more efficiently. In addition, the skills graph can be stored in a more compact way. In summary, this embodiment saves computational and storage resources.

In some aspects, skill topics in the skills graph can be assigned to categories and hierarchies.

### Building Skill Profiles

In another general aspect, the disclosure provides computer-implemented methods for building a skill profile of an entity. Within the context of the present disclosure, an entity may be a person/user, a job role, a job posting, a project, a work assignment, or a training. Further, a skill profile is a list of skill topics from the skills graph, optionally a ranked and/or weighted list of skill topics from the skills graph. When associated to an entity, the skill profile can further be organized by a user by grouping the skill topics into user-defined levels.

An exemplary and non-limiting computer-implemented method for building a skill profile of an entity comprises the following steps: a) processing at least one input document to generate a plurality of phrases, wherein the at least one input document contains information about the entity; b) building a skills graph, in particular as described above; c) matching at least some of the phrases to one or more skill labels (skill label nodes) from the skills graph; d) for each skill label that is matched to a phrase, identifying at least one skill topic (skill topic node) in the skills graph, in particular based on the label association score, and adding the skill topic to the skill profile of the entity; e) computing a relevance score for each skill topic in the skill profile based on the input document.

The above method thus models an entity basically as a list of skill topics from the skills graph. The skill profile of the entity, however, does not contain only the list of skills, but also a relevance score for each skill. The relevance score indicates the relevance of the particular skill topic to the entity.

In some aspects, the at least one input document processed in step a) can be, depending on the particular entity, a CV, a job posting, a project description, etc.

As a skill profile is essentially characterized by the list of associated skill topics and corresponding weights (e.g., relevance score values), skill profiles may be embedded into the skills graph as follows: For each skill profile, a dedicated skill profile node is added as a node to the skills graph, wherein the skills profile node is connected by a weighted edge to each skill topic contained in the skill profile, wherein the edge weight corresponds to the relevance score. This way, skill profile information can be maintained efficiently in the data structure of the skills graph.

In some aspects, step a) of the method for building the skill profile comprises at least one of the following steps: i) extracting phrases, in particular nouns and/or verbs, from the at least one input document; ii) applying a classification procedure on extracted phrases for classifying the phrases into one of a plurality of classes, comprising at least one skill-class and at least one non-skill class.

In particular, for processing the at least one input document, any of the methods or techniques described in connection with the method of building the skills graph can be used. This may include, e.g., employing a large language model to discover the phrases of skill classes. This will result in similar advantages as described above.

In some aspects, step c) of the method for building the skill profile (that is, the matching of phrases to skill labels from the skills graph) comprises applying an algorithm for fuzzy string matching.

By fuzzy string matching (also called approximate string matching), it is possible to match strings which are not exactly identical, but similar in terms of a string metric. For example, the string metric may be defined according to the Damerau-Levenshtein distance, the Sorensen-Dice coefficient, the Jaro-Winkler distance or combinations thereof, applied over the root forms of the words in the skill label and/or skill topic. Depending on the language to be processed, further heuristics, text and network embeddings may be used, for example, in the case of German language, additional heuristics for articles and a probabilistic model to account for concatenated nouns.

In some aspects, in step e) of the method, the relevance score for each skill topic is computed based on at least one of the following: i) number of occurrences of the corresponding phrase in the at least one input document; ii) a position of the corresponding phrase in the at least one input document; iii) a skill relation score of a second skill topic identified in the at least one input document. The relevance score for each skill topic may be computed, e.g., based on a context score, which is computed by aggregating the skill relation scores to other skill topics that are identified in the at least one input document.

The corresponding phrase of a skill topic can be the phrase extracted from the at least one input document that has been associated with the skill topic via the skill label.

In some aspects, the method for building the skill profile comprises further the following step: loading a template associated with the at least one input document, wherein the template defines a section weight for each section of the at least one input document.

In step e), the relevance score for each skill topic may be computed further based on the section weight of the section that comprises the phrase corresponding to the skill topic.

This embodiment takes into account the fact that input documents (for example CVs, job postings, etc.) typically have several sections structuring the document. For example, a job posting may have the following sections: (1) a header section indicative of the job role that is requested; (2) a section specifying essential requirements (e.g., educational degree, completed certifications, etc.) of an applicant; and (3) a section specifying optional requirements (e.g., international experience, expertise in special fields, etc.). This structure also provides implications on the role and/or importance of phrases extracted from different sections of the input document. In this case, a suitable template may assign a larger weight to the header section (1) than to the sections (2) and (3), and may assign a larger weight to the essential requirements section (2) than to the optional requirements section (3).

By defining the relevance score in the skill profile in accordance with the weights provided by the template, the importance of phrases extracted from the input document can be reflected in the skill profile. This way, the accuracy of the skill profile can be improved, and better recommendations can be obtained based on the skill profile.

In some aspects, the method further comprises the following step: assigning each skill topic from the skill profile to one of multiple levels according to the relevance score associated with the skill topic. According to this embodiment, the generated skill profile can be structured further by grouping the identified skill topics according to their relevance score. For this purpose, each level may be defined in terms of a relevance score interval. For example, the levels of person's skill profile may reflect the person's proficiency in the respective skills, wherein level 1 indicates expert skills, level 2 indicates advanced skills, and level 3 indicated beginner skills.

In some aspects, the method further comprises the following steps: i) receiving a user input specifying at least one level for a skill topic; and/or ii) updating the assignment of skill topics to levels according to the user input. By this embodiment, a user is enabled to manually adapt the assignment of skills to the plurality of levels. This way, individual preferences or ratings can be specified in the skill profile.

### Generating Recommendations

In another general aspect, the disclosure provides a computer-implemented method for determining at least one target entity for a source entity. Again, the term entity can relate to a person or user, a job role, a job posting, a project, a work assignment, a training, etc.

An exemplary and non-limiting computer-implemented method for determining at least one target entity for a source entity may comprise the following steps: a) building a skills graph, in particular as described above; b) building a skill profile of the source entity, in particular as described above; c) building a skill profile for at least one target entity candidate, in particular as described above; d) for each source skill from the skill profile of the source entity: i) perform an iterated neighborhood search in the skills graph, starting from the source skill, until at least one target skill is identified, wherein a target skill is a skill topic associated with the skill profile of a target entity candidate, and ii) compute a weighted score for the at least one target skill; e) compute a total relevance score for each target entity candidate, based on relevance scores of skill topics from the skill profile of the target entity candidate; and f) provide a recommendation list comprising each target entity candidate together with its total relevance score.

In simple terms, the method is based on comparing the skill profile of the source entity with a skill profile of a target entity candidate (or multiple skill profiles associated with multiple target entity candidates) by using the skill relation scores from the skills graph (i.e., the edge weights) and the relevance scores from the skill profiles. As a result, a list of the target entity candidates is generated, which also provides, for each recommendation (target entity), the degree of relevance for the source entity. For example, the above method allows to generate for a person (=source entity) a list of job descriptions (=target entities) that are relevant for the person, based on a comparison of the respective skill profiles. Preferably, the target entity candidates are provided as further input to the method, so that their skill profiles can be computed in advance. Alternatively, the target entity candidates may be determined based on the source entity's skill profile.

In some aspects, the weighted score for the at least one target skill is a linear combination of at least one of the following: i) a weight of the source skill according to the skill profile of the source entity; ii) a weight of the target skill according to the skill profile of the target entity candidate; and/or iii) the skill relation scores of any pair of skill topics that is adjacent in the skills graph and is located on a path between the source skill and the target skill. Here, the weight of the source skill depends on a level of the source skill and on the relevance score of the source skill in the skill profile of the source entity. Accordingly, the weight of the target skill depends on a level of the target skill and on the relevance score of the target skill in the skill profile of the target entity.

In some aspects, the iterated neighborhood search follows a breadth-first-search principle. In a breadth-first search, starting from one node in a graph, only the direct neighbors of the node are explored in a first stage. Then, in a next stage, the neighbors of the neighbors of the node are traversed, and so on. This way, a breadth-first search explores all nodes at a current depth level prior to exploring nodes on a higher depth level.

The relevance of a target entity candidate to the source entity candidate typically decreases with increasing distance (e.g., measured by number of edges) of the corresponding skill topics in the skills graph. By implementing the iterated neighborhood search according to a breadth-first-search, target entity candidates that are relatively close to the source entity are explored first. Therefore, it can be avoided that the method explores skill topics that are only loosely connected to a skill topic of the source entity, which means that the relevance of the explored skill topic is negligible for the recommendation. This way, the described embodiment provides the effect that target entities can be determined efficiently.

In some aspects, the iterated neighborhood search (in step d) is performed until a predetermined number of different target entity candidates are covered. This enables, for example, that a user can obtain a “top 5 list” of job recommendations.

In some aspects, the method comprises further the following steps: i) receiving user input comprising instructions for adapting the recommendation list; and ii) adapting the recommendation list according to the user input. In particular, the instructions can comprise a set of target entities to be deleted from the recommendation list and/or specify an updated order of the target entities in the recommendation list.

In some aspects, the method comprises further the following steps: i) receiving user input indicative of a favorites list comprising target entities from the recommendation list; and ii) storing the favorites list in a user profile. This way, a user can select a subset of the items from the recommendation list as a personal “favorites list” based on individual preferences and save the favorites list for later consideration.

In some aspects, the user profile may be stored on a server implementing the described method, wherein the user profile is associated with the source entity.

### Identifying Gap Skills

The problem is further solved by a computer-implemented method for determining gap skills for a source entity with respect to a target entity. Generally, the term gap skill refers to a skill topic that is part of the skill profile of a first entity but not part of the skill profile of the second entity. For example, when comparing the skill profile of a person (=source entity) with the skill profile of a job (=target entity) the person wishes to apply for, gap skills correspond to the requirements specified in the job description that are (presently) not satisfied according to the person's skill profile. The identified gap skills can be used to recommend a training to the person, so that after completing the training, the person's skill profile is enhanced and matches the skill profile of the job.

An exemplary and non-limiting computer-implemented method for determining gap skills for a source entity with respect to a target entity may comprise the following steps: a) building a skills graph, in particular as described above; b) building respective skill profiles of the source entity and the target entity, in particular as described above; c) determining a list of gap skills, based on a difference between the skill profile of the target entity and the skill profile of the source entity; d) for each gap skill from the list of gap skills, i) checking whether there exists a proxy skill topic in the skill profile of the source entity such that a relation score of the gap skill and the proxy skill topic exceeds a threshold value, and ii) removing the gap skill from the list of gap skills if the proxy skill topic exists; and e) providing the list of gap skills.

The list of gap skills provided by the method may be based on the skill topic difference of the skill profile of the target entity and the skill profile of the source entity. The list of gap skills may correspond to the set difference between both skill profiles, that is, the (preliminary) list of gap skills determined in step c) may equal the list of all skill topics that are: i) part of the skill profile of the target entity; and ii) not part of the skill profile of the source entity.

According to another definition of gap skills, proficiency levels associated with the skill profiles in each skill profile are taken into account to determine the list of gap skills. That is, the list of gap skills determined in step c) may contain each skill topic from the skill profile of the target entity that is i) not part of the skill profile of the source entity; or ii) differs in proficiency level compared to the corresponding skill topic from the source entity.

However, in step d) of the method, some of the gap skills may be removed from the list, namely gap skills that have a so-called proxy skill topic in the source entity's skill profile. A proxy skill topic is a skill topic from the source entity's skill profile that is closely connected (in terms of skill relation score and/or relevance score) to the gap skill. Intuitively, the reasoning behind step d) is that a skill topic should not be considered a gap skill if a different but (very) similar skill topic exists in the source entity's skill profile. For example, if a job description (target entity) requires the skill topic “Microsoft Azure Functions” and the skill profile of the user (source entity) contains the skill topic “Serverless services”, the latter skill topic should be considered a proxy skill.

The relation score of the gap skill and the proxy skill may be obtained as a linear combination of one or more of: i) the relevance score of the proxy skill from the source entity's skill profile; ii) the relevance score of the gap skill from the target entity's skill profile; and/or iii) the skill relation score between the proxy skill and the gap skill.

In some aspects, the list of gap skills is provided in a sorted order in accordance with levels of the corresponding skill topics in the skill profile of the target entity. This way, the importance of the gap skill (as specified in the target entity's skill profile) can be reflected in the list of gap skills.

In some aspects, the method further comprises following steps: i) identifying at least one training based on the list of gap skills; and ii) providing a list of trainings to a user, the list comprising the at least one identified training.

Again, in some cases it may be preferred that the list of trainings is provided in sorted order, wherein the sorted order is in accordance with levels of the corresponding skill topics in the skill profile of the target entity.

### Incorporating Organizational Competencies

In another general aspect, the disclosure provides a computer-implemented method for mapping organizational competencies. Discovering competency gaps, continually or with regard to an organization's transformation goal, allows HR decision-makers to develop mobility and learning initiatives for the organization.

As explained above, a skill refers to the ability to perform a specific task or function, often acquired through training, experience, or practice. Skills can be technical (e.g., coding, accounting, or data analysis) or soft (e.g., communication, problem-solving, or teamwork). They are often quantifiable and can be developed through targeted training and practice.

On the other hand, a competency defined in an organizational context refers to the application of a skill, or a combination thereof, to achieve a specific task or perform in a job role. Competency combines skills needed to perform a task with the knowledge, attitudes, and behaviors that enable someone to execute effectively in a particular role or function. Competencies may be defined, e.g., as a set of skills, experience, and/or personal attributes needed to allow someone to perform effectively in a given context. Competencies can be job-specific (e.g., project management, sales) or function-specific (e.g., leadership, adaptability, or collaboration); they are established by organization through job role descriptions. Whether or not a person is competent for the job role is determined through interviews and assessments of the respective competencies of the role.

In particular, the following aspects can be considered to determine if a topic is either a skill or a competency:
1) Scope: If the topic is focused on a specific ability or technique, it is a skill. If it involves a combination of skills, knowledge, attitudes, and/or behaviors, it is a competency.
2) Measurability: Skills are often easier to quantify and measure, while competencies require a more comprehensive assessment that includes performance reviews, feedback, or other qualitative evaluations.
3) Development: If the topic can be improved primarily through training and practice, it is a skill. If it requires a more holistic approach to personal and professional development, it is a competency.

In summary, skills are specific abilities or techniques, while competencies encompass a broader range of skills, knowledge, attitudes, and behaviors that contribute to effective performance in a given role or function.

An exemplary and non-limiting method for mapping organizational competencies may comprise the following steps: a) building a skills graph, in particular as described above; b) processing at least one input list of competencies associated with an organization, in particular by processing at least one job description associated with the organization; c) for each competency listed in the job description, identifying associated skill topics from the skills graph to build a competency model; and d) for each competency and one or more source entities, in particular a person, a job, project, or work assignment, determining a competency gap based on the competency model and corresponding skill profiles of the one or more source entities.

As described above, competencies are broader concepts that require application of one or multiple skill topics in combination as per the requirement. The above method allows to process an input list of competencies, for example, by extracting corresponding phrases from a job description of an organization, and to build a competency model for each competency by identifying associated skill topics from the skills graph. Since the competency model can be basically a (weighted) list of skill topics, all techniques described above with respect to skill profiles, recommendation generation, identifying gap skills can be applied. Therefore, based on the competency model and a skill profile of each source entity, a competency gap can be determined. A competency gap captures one or more missing skills from (c), or a difference in level for an existing skill in (c) to the skill profile of the source entity.

In one embodiment, step d) includes determining one or more gap skills, in particular using the method for determining gap skills as described above, for the one or more source entities with respect to the competency model as a target entity. Here, the competency gap includes at least some of the determined gap skills. Competency gaps can be aggregated at the individual, team, department, and organization levels to get analytics for competencies and associated skills. Moreover, competency gaps can be proactively addressed for the job roles by developing targeted learning programs personalized to individual, team, or department that address the skill gap underneath.

In some aspects, the method further comprises identifying at least one training or a series of trainings based on the one or more gap skills. In particular, an organization may develop competency goals for business transformation initiatives and provide learning and training programs that address the additional skills required for achieving the competency goals.

### Skills-based Description Generation for Job Roles, Job Postings, Projects and Work Assignments

In another general aspect, the disclosure provides a computer-implemented method for generating descriptions for an entity, in particular for an organizational job role, job posting, project, or work assignment. An exemplary and non-limiting method according to this aspect may comprise the following steps: a) generating a skills graph, in particular as described before; b) training and/or fine-tuning a language model, in particular a large language model, using textual data descriptive of skills, job roles, job postings and/or projects; c) receiving, as a user input, a title for the entity; d) receiving, as a user input, a list of skill topics from the skills graph; e) applying the language model on the title for generating a description, in particular in natural language, about the entity; and f) generating a list of responsibilities and activities for the entity by using template queries on the language model, the template queries including the title and the list of skill topics.

In particular, the language model may be configured to take as input an instruction to generate a description along with a list of skill topics that are required and to produce a textual description of responsibilities and activities.

### Systems for Implementing the Methods Described Herein

In another general aspect, the disclosure provides systems for implanting the methods described herein. An exemplary and non-limiting system may comprise the following: a storage unit, configured to store a skills graph; an input document interface, configured to process at least one input document, in particular a textual input document; a knowledge database interface, configured to provide a connection to a knowledge database, in particular an online encyclopedia; a user interface, configured to receive user input; a processing unit, configured to perform any of the method described above using the storage unit, the input document interface, the knowledge database interface and the user interface.

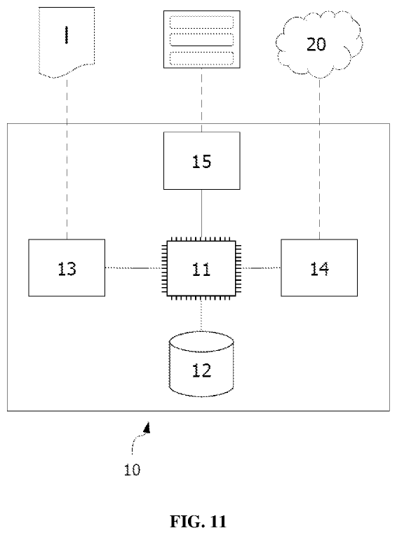

FIG. 11 shows an example of a system 10 for implementing any of the methods described above. The system 10 comprises a storage unit 12 configured to store the skills graph and a processing unit 11 which is configured to perform the method using the storage unit 12 and the following interfaces, which are connected to the processing unit 11: the input document interface 13; the knowledge database interface 14; and the user interface 15. The input document interface may be configured to receive input documents I (for example, textual input documents), which may be used to generate the skills graph and skill profiles of entities. The knowledge database interface 14 may be configured to send queries to at least one knowledge database 20 (e.g., a public online encyclopedia) and to receive answers from the knowledge database 20. The user interface 15 may be configured to receive input data from a user of the system, for example instructions for adjusting a skill profile. Moreover, the user interface 15 may be configured to provide results of the method (e.g., skill profiles or recommendations), to the user of the system.

### Computer-Readable Media

In another general aspect, the disclosure provides a computer-readable medium comprising instructions that, when executed by at least one processor, cause the at least one processor to implement any combination (or all) of the steps of any method disclosed herein.

### Examples

The following examples are non-limiting and merely illustrative of systems and methods in accordance with the disclosure.

### Example 1: An Exemplary System for Generating a Skills Graph

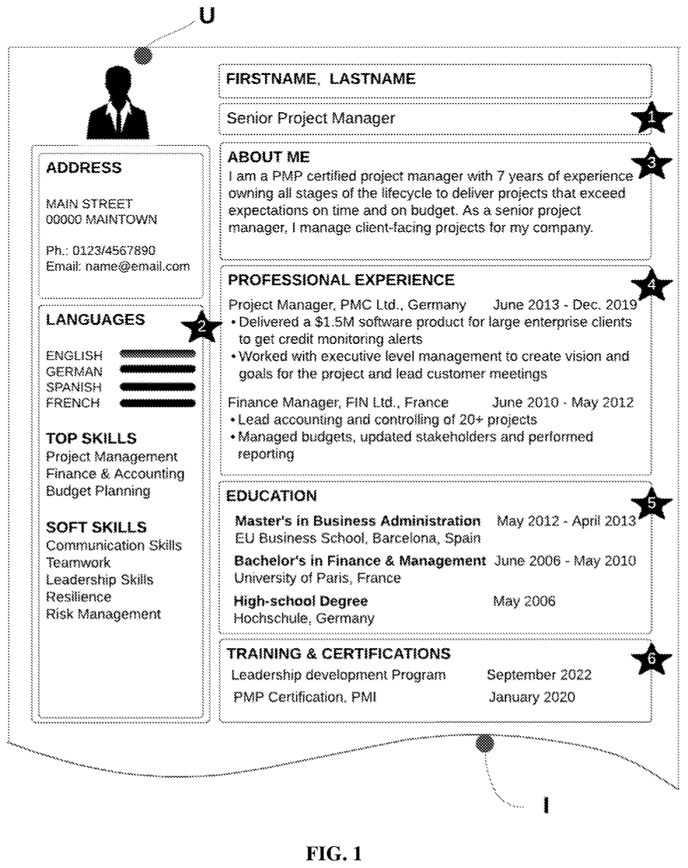

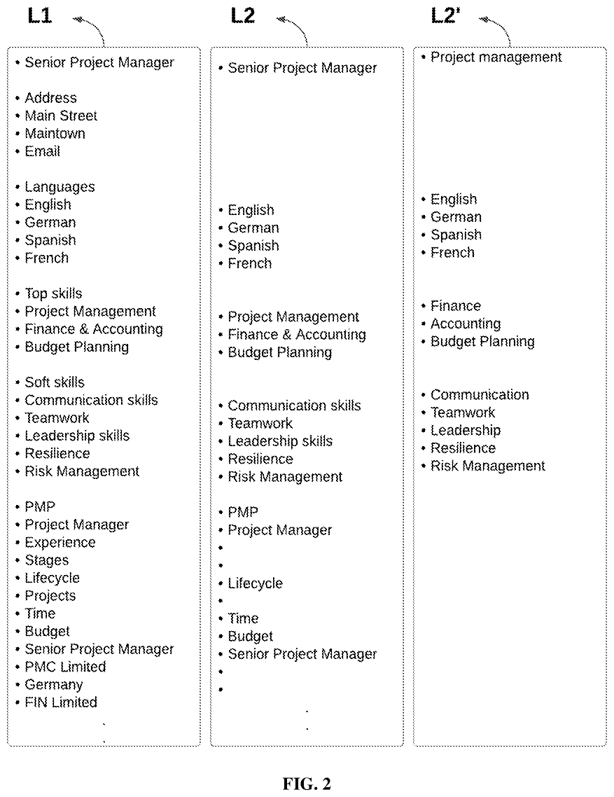

FIG. 1. shows an example of a textual input document I. In this example, the input document I is a CV of the person (entity) U. The CV is a text document structured into different sections 1-6: (1) Name and job position; (2) Languages and skills; (3) Personal information; (4) Professional experience; (5) Education; and (6) Training and certifications. Each section comprises textual data related to the respective section. The textual data can be used to extract skill topic candidates, as described in connection with FIG. 2.

FIG. 2 shows a list L1 of candidate skill topics extracted from the textual document I of FIG. 1. Moreover, FIG. 2 shows lists L2 and L2′ of skill topics. Specifically, the list L1 has been created by: i) parsing the textual data of each section of the CV; ii) classifying the word type of each word; and iii) adding nouns of the CV as candidate skill topics to the list L1.

As a consequence, the list L1 comprises both terms that are related to a skill topic (e.g. “project management”) and terms that are nouns, but not related to any skill (e.g. “years”).

List L2 is a subset of list L1 and has been obtained from filtering the list L1 using a machine learning classifier. The machine learning classifier has been trained to classify a term as positive (skill topic) or negative (no skill topic).

List L2′ has been obtained from list L2 by manipulating the skill topics from list L2 and by removing synonyms. For example, the term “senior project manager” has been replaced by “project management” since the latter term is descriptive of a skill topic, wherein the first term relates to a job role. For example, this operation can be performed by querying the term “senior project manager” in a public knowledge database and identifying that the public knowledge database answers the query with an entry entitled “project management”. In addition, the term “finance & accounting” has been separated into two terms “Finance” and “Accounting”. This can be performed algorithmically by identifying respective characters (e.g., “&”) and splitting the string appropriately. As a result, the list L2′ is a filtered list of skill topics obtained from the input document I of FIG. 1.

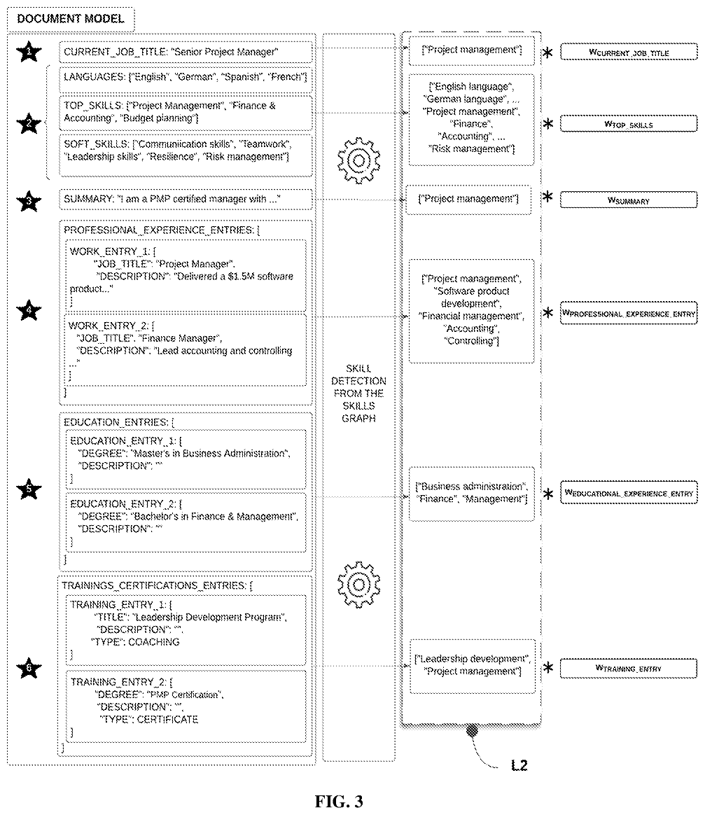

It should be understood that for a structured text document like the CV from FIG. 1, the process of generating the list of skill topics described in connection with FIG. 2 can be improved by exploiting structural information of the document, if present. For example, from the respective section titles of document I from FIG. 1, it can be expected and utilized that the sections “skills” and “languages” contain items that most likely describe skill topics. As an example, FIG. 3 shows a list of skill topics L2 that has been obtained from the CV of FIG. 1, wherein a document model has been used. The document model allows one to extract structured information from the input document, which can be used to improve the process of creating the list of skill topics L2. However, it should be understood that the method described herein does not require such structural information and can process plain textual documents as well (as explained in connection with FIG. 2).

### Example 2: An Exemplary Skills Graph

FIG. 4 shows one example of a skills graph G. The skills graph G has been generated based on a reduced version of the skill topic list L2′ described in connection with FIG. 2 (for ease of presentation, list L2′ has been reduced to five skill topics). It is assumed that the skill relation scores, skill labels and the label association score have been computed using the techniques described in the general part of this application. In this representative skills graph, skill topic nodes are shown as rectangles and edges between two skill topics are shown as solid lines. Skill label nodes are shown as circles and edges between a skill topic and an associated skill label are shown as dashed lines.

Skills graph G comprises five skill topic nodes: “Teamwork,” “communication,” “resilience,” “finance,” and “project management.” Each skill topic node is connected with each other skill topic node by a weighted edge, wherein the weight of the edge indicates the skill relation score of the two skill topics. For example, the skill topics “teamwork” and “communication” have a skill relation score of 0.8, which reflects the strong semantic relationship between both skill topics. On the other hand, the skill topics “communication” and “finance” have a significantly smaller skill relation score of 0.12.

In the exemplary skills graph G shown in FIG. 4, each skill topic is associated with one or more skill labels. As explained before, skill labels can be used to associate synonyms, alternative terms, abbreviations, etc. to a skill topic. In some aspects, skill labels may correspond to translations of a primary term of a skill topic into other languages. This way, the skills graph may be configured to contain multi-language information and be adapted to match syntactically different terms from different languages to the same semantic skill topic. For example, the skill topic “project management” is associated with two skill labels: “management of projects” and “Projekt-Management.” The skill label “management of projects” can be considered an alternative term for “project management” which may be used interchangeably (in particular, in the processed input documents). The skill label “Projekt-Management” represents the German translation of “project management”.

In this example, each skill label node is connected to at least one skill topic node by a weighted edge, wherein the edge weight corresponds to the label association score. In case of the skills graph of FIG. 4, any skill label node is connected to only one skill topic node. As a consequence, all corresponding label association scores are equal to 1.0 in this example. In cases where a single skill label is associated with more than one skill topic, the skill relation score may be smaller than one, reflecting that the skill label cannot be assigned uniquely to a single skill topic (see below the example from FIG. 5).

### Example 3: A Second Exemplary Skills Graph

FIG. 5 shows an example of a skills graph G having two skill topic nodes “Natural language processing” and “non-linear programming.” The skill label node “NLP” is connected to both skill topic nodes, since in the field of computer science, the abbreviation NLP is associated to both topics. However, for example from a statistical analysis, it may be derived that the term NLP is usually more likely to refer to “non-linear programming” as compared to “natural language processing.” Therefore, computation of the corresponding label association score may result in a label association score of: 0.7 between “NLP” and “non-linear programming”; and 0.3 between “NLP” and “natural language processing.” In addition, both skill topics have one additional associated skill label, which is associated with the respective skill topic exclusively.

### Example 4: Exemplary Skills Profiles

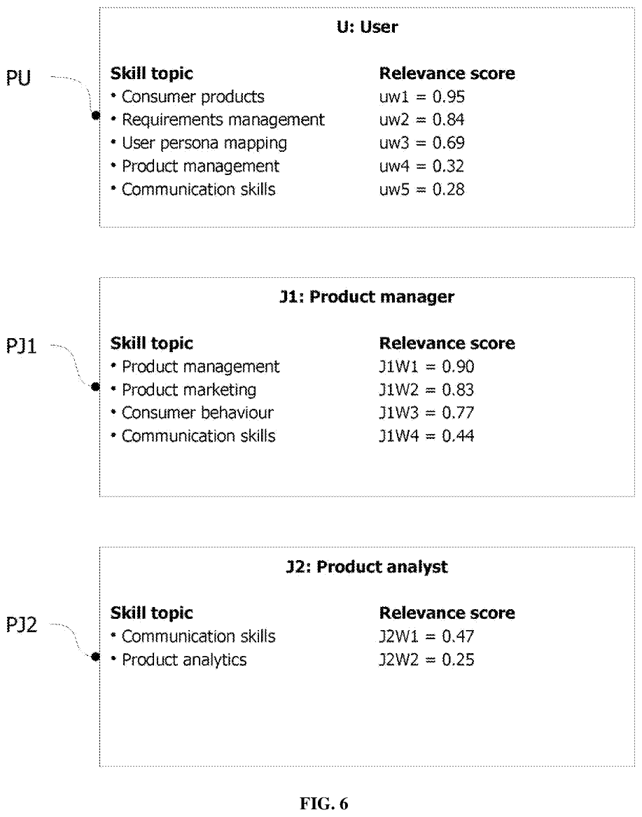

FIG. 6 shows three examples of skill profiles PU, PJ1, PJ2 of entities U (user), J1 (job description “product manager”) and J2 (job description “product analyst”). Each of the skill profiles PU, PJ1 and PJ2 comprises an ordered list of skill topics and relevance scores associated with each skill topic. In this embodiment, relevance scores are numerical values between 0 and 1. For example, in the skill profile PU, the skill topic “consumer products” has a relevance score of uw1=0.95. This indicates that the skill topic “consumer product” is of high relevance in the skill profile PU, which may reflect that the user U has a strong professional background in the field of consumer products.

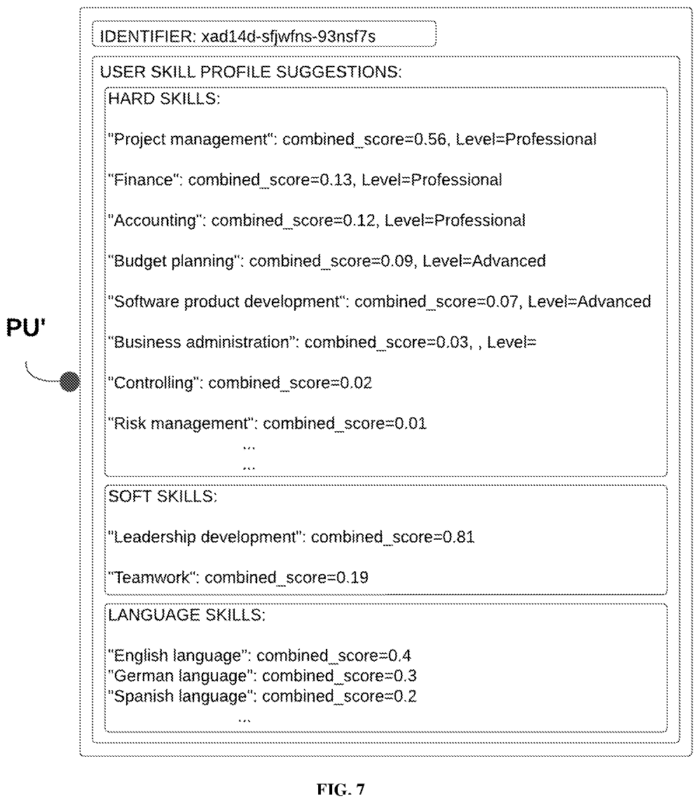

FIG. 7 shows another example of a skill profile PU′ for a person entity. As in the case of the skill profiles PU, PJ1 and PJ2 from FIG. 6, the skill profile PU′ comprises an ordered list of skill topics with associated relevance scores (in FIG. 7 denoted as “combined_score”). However, the skill profile PU′ provides additional structural information about the skill topics. In particular, skill topics are grouped into three categories “hard skills,” “soft skills,” and “language skills.” Moreover, at least some of the skill topics from the hard skills section have associated levels. For example, the hard skills “project management,” “finance,” and “accounting” are each associated with the level “professional,” the hard skills “budget planning” and “software product development” are associated with the level “advanced.” In particular, the levels may be inferred according to ranges (=intervals) of the relevance scores, for example by inferring the “professional” level from the relevance score interval [0.1, 1] and the “advanced” level from the relevance score interval [0.05, 0.1). Optionally, the levels can be re-assigned by a user after this inference.

### Example 5: A Third Exemplary Skills Graph

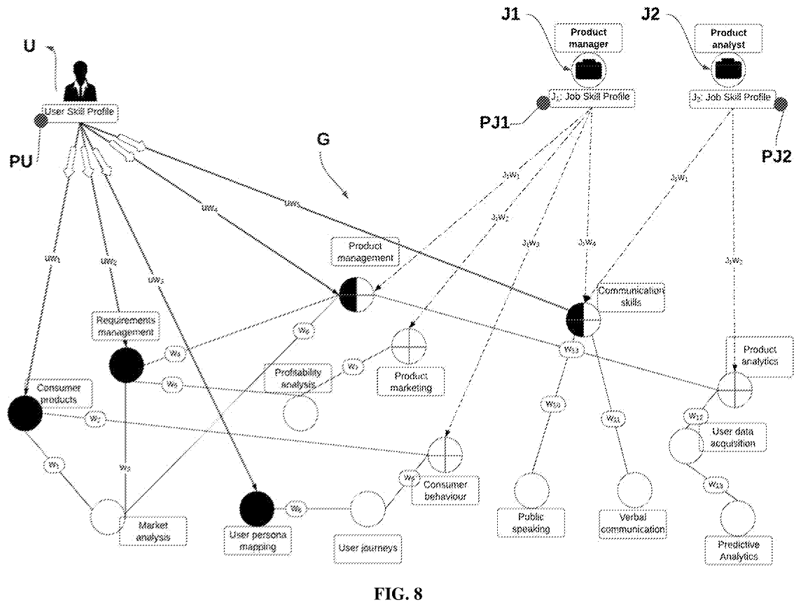

FIG. 8 shows another example of a skills graph G (for simplicity, without skill labels). In the presentation of FIG. 8, the skill profiles PU, PJ1 and PJ2 from FIG. 6 are embedded into the skills graph G by introducing additional skill profile nodes and corresponding weighted edges. With reference to FIG. 8, the method of generating recommendations for a source entity can be explained. In this embodiment, the source entity is the person U having the skill profile PU, and target entity candidates are the job descriptions J1 (“product manager”) and J2 (“product analyst”) having the skill profiles PJ1 and PJ2, respectively. The goal is to generate a recommendation list in which both target entity candidates J1, J2 are associated with a total relevance score. In simple terms, the recommendation list indicates how relevant the job descriptions “product manager” and “product analyst” are for the person U, based on a comparison of the corresponding skill profiles PU, PJ1, PJ2.

In the following, the procedure for generating the recommendation list is described, with a focus on the computations of relevance scores. According to the skill profile PU, the following skill topics (called “source skills”) are associated with the person U (see FIG. 6): “consumer products”; “requirements management”; “user persona mapping”; “product management” and “communication skills.”

According to the skill profile PJ1, the following skill topics (called “target skills”) are associated with the job description “product manager”: “product management”; “product marketing”; “consumer behavior” and “communication skills.”

Now, for each pair of a source skill of skill profile PU and a target skill of skill profile PJ1, a weighted score is computed, by computing a linear combination of relevance scores (from the corresponding skill profiles) and skill relation scores (that is, skill-to-skill-connections) from the skills graph G. Here, all paths in the skills graph G between the source skill node and the target skill node are considered and summed up.

The following tables shows the weighted scores for each source skill and each of the target skills.

TABLE 1
Weighted scores for each source skill and each of several target skills.
SOURCE SKILL “CONSUMER PRODUCTS”

| Target Skill | Weighted Score |
|---|---|
| Product Management | uw1 * w1 * w3 * w4 * J1W1 + |
| | uw1 * w1 * w6 * J1W1 |
| Product Marketing | uw1 * w3 * w5 * w7 * J1W2 |
| Consumer Behavior | uw1 * w2 * J1W3 |
| Communication Skills | 0 |

TABLE 2
Weighted scores for each source skill and each of several target skills.
SOURCE SKILL “REQUIREMENTS MANAGEMENT”

| Target Skill | Weighted Score |
|---|---|
| Product Management | uw2 * w4 * J1W1 + uw2 * w3 * w6 * J1W1 |
| Product Marketing | uw2 * w5 * 7 * J1W2 |
| Consumer Behavior | 0 |
| Communication Skills | 0 |

TABLE 3
Weighted scores for each source skill and each of several target skills.
SOURCE SKILL “PRODUCT MANAGEMENT”

| Target Skill | Weighted Score |
|---|---|
| Product Management | 0 |
| Product Marketing | 0 |
| Consumer Behavior | uw3 * w8 * w9 * J1W3 |
| Communication Skills | 0 |

TABLE 4
Weighted scores for each source skill and each of several target skills.
SOURCE SKILL “PRODUCT MANAGEMENT”

| Target Skill | Weighted Score |
|---|---|
| Product Management | 0 |
| Product Marketing | 0 |
| Consumer Behavior | uw3 * w8 * w9 * J1W3 |
| Communication Skills | 0 |

TABLE 5
Weighted scores for each source skill and each of several target skills.
SOURCE SKILL “COMMUNICATION SKILLS”

| Target Skill | Weighted Score |
|---|---|
| Product Management | 0 |
| Product Marketing | 0 |
| Consumer Behavior | 0 |
| Communication Skills | uw5 * J1W4 + uw5 * J2W1 |

The total relevance score of the job description J1 for the person U can be obtained by summing up each of the above weighted scores: (uw1*w1*w3*w4*J1W1)+(uw1*w1*w6*J1W1)+(uw1*w3*w5*w7*J1W2)+(uw1*w2*J1W3)+(uw2*w4*J1W1)+(uw2*w3*w6*J1W1)+(uw2*w5*7*J1W2)+(uw3*w8*w9*J1W3)+(uw4*J1W1)+(uw5*J1W4*J2W1).

The total relevance score of the job description J2 (“product analyst”) for the person U can be obtained in the same manner. Here, the following total relevance score results: (uw1*w1*w3*w4*w13*J2W2)+(uw2*w4*w13*J2W2)+(uw2*w3*w6*w13*J2W2)+(uw4*w13*J2W2)+(uw5*J2W1).

The recommendation list, which is the result of the recommendation procedure, contains references to J1 and J2 together with the numerical values of the respective total relevance scores as described above.

While not demonstrated in this example figure, additional weighting can be applied to treat hard skills, soft skills and language skills differently in the overall weighting.

### Example 6: A Fourth Exemplary Skills Graph

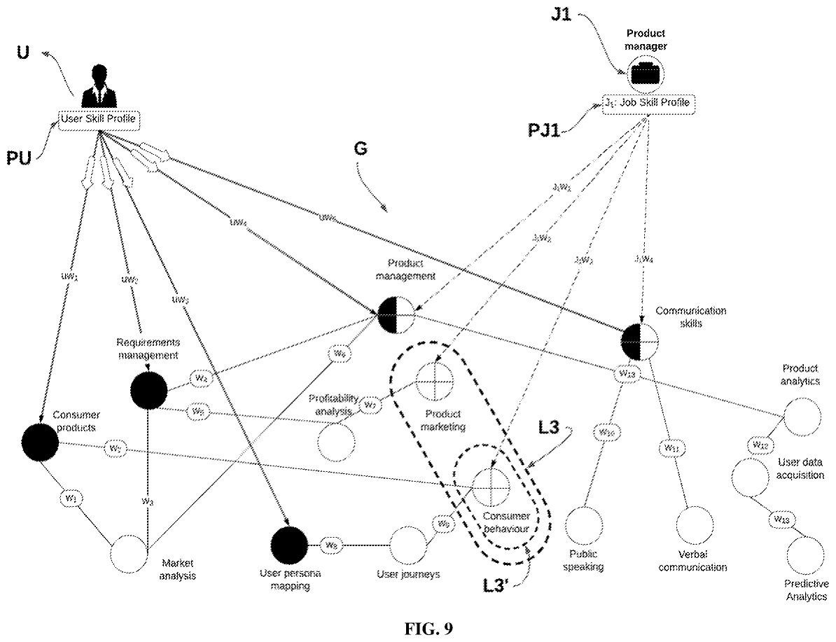

FIG. 9 shows the skills graph G, which is similar to the skills graph G from FIG. 8. The skill profile PU (of the person U) and the skill profile PJ1 (of the job description J1) are embedded into the skills graph G. Using FIG. 9, the method of identifying gap skills can be explained. In this embodiment, the person U is considered the source entity and the job description J1 is considered the target entity. In the following, it is assumed that the skills graph G and the respective skill profiles PU, PJ1 have been built in advance (as described with respect to FIG. 7 and FIG. 9).

Intuitively, the goal is to identify skills that are required by the job description of “product manager” (J1) but not provided by the skill profile PU of the person U. In a first stage, a first list L3 of gap skills is obtained from the set difference between the skill profile PJ1 and the skill profile PU. Since the skill topics “product marketing” and “consumer behavior” are part of the skill profile PJ1, but not part of the skill profile PU, the first list L3 of gap skills comprises the gap skills “product marketing” and “consumer behavior.” In the second stage, the goal is to generate a filtered list L3′ based on the first list L3 of gap skills. Intuitively, a skill topic should not be considered a gap skill if there is a different skill topic (called proxy skill) from the source entity's skill profile such that there is a strong connection to the gap skill.

In case of FIG. 9, “consumer products” may be a proxy skill for the gap skill “consumer behavior.” The relation score between “consumer products” and “consumer behavior” may be computed as: uw1*w2*J1W3.

In this embodiment, it is assumed that the numerical value of the above relation score exceeds a given threshold for identifying proxy skills. Therefore, the filtered list L3 of gap skills contains only “product marketing.” Hence, “product marketing” is the only gap skill of the skill profile PU with respect to the skill profile PJ1. The identified gap skill can be used to recommend a training to the person U, wherein the training provides the gap skill “product marketing” to the attendees. Since trainings can also be modeled as entities with associated skill profiles, trainings can be embedded in the skills graph G as well. Therefore, identifying a training for an identified gap skill can be performed by exploring the incoming edges of the gap skill in the skills graph.

### Example 7: Generation of an Exemplary Job Description Using a LLM

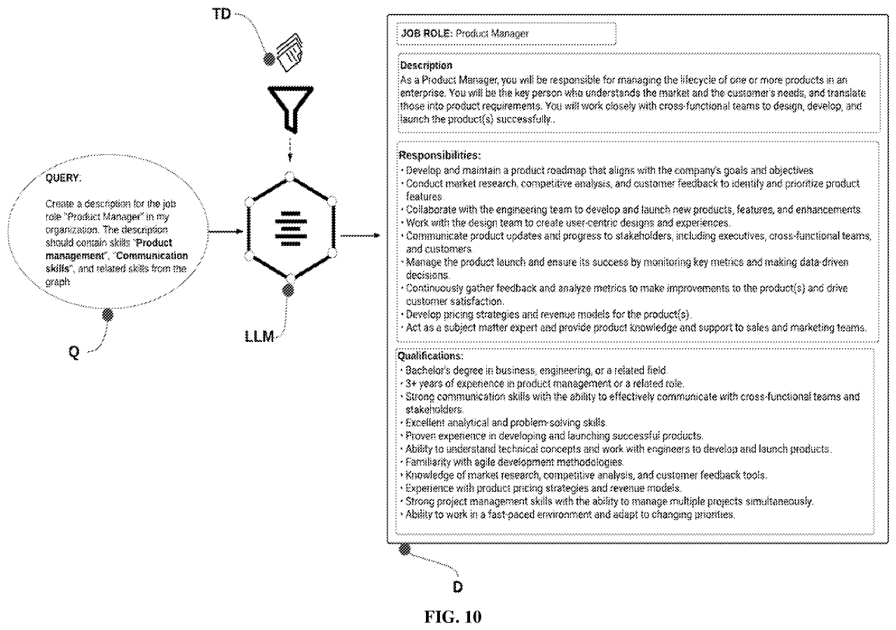

FIG. 10 illustrates the generation of a job description using the large language model LLM. Specifically, the large language model LLM may be trained and fine-tuned based on the training data TD, which comprises organization's data including textual descriptions of existing job families, job roles, etc. This way, the large language model LLM can be adapted to output the job description D when provided with the user query Q. According to the shown embodiment, the user query Q corresponds to the following query: “Create a description for the job role ‘Product Manager’ in my organization. The description should contain skills ‘Product management,’ ‘Communication skills,’ and related skills from the skills graph,” wherein it is assumed that a skills graph containing the skill topics “Product management and “Communication skills” has been generated in advance and is available to the LLM.

The output generated by the large language model LLM is the textual description D of the job role. In accordance with the requirements specified in the user query Q, the description “D” has the title “Product Manager” and lists several qualifications, including “product management” and “communication skills”.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (for example, “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (and equivalent open-ended transitional phrases thereof like including, containing and having) encompasses all the expressly recited elements, limitations, steps and/or features alone or in combination with unrecited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amended for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Lastly, the terminology used herein is for the purpose of describing particular embodiments only, and is not intended to limit the scope of the present invention, which is defined solely by the claims. Accordingly, the present invention is not limited to that precisely as shown and described.

### LIST OF REFERENCE SIGNS

10 System
11 Processing unit
12 Storage unit
13 Input document interface
14 knowledge database interface
15 user interface
20 knowledge database
D description
G skills graph
I input document
J1, J2 job descriptions (target entities)
L1 list of skill topic candidates
L2, L2′ list of skill topics
L3, L3′ list of gap skills
LLM large language model
PU, PJ1, PJ2 skill profiles
TD training data
U person (source entity)
Q query

1. A computer-implemented method for generating a skills graph, comprising:
a) processing, by a computer, at least one input document to generate a list of candidate skill topics;
b) generating, by the computer, a list of skill topics based on the list of candidate skill topics;
c) generating, by the computer, a skill relation score for each pair of skill topics;
d) generating, by the computer, a plurality of skill labels associated with at least some of the skill topics, using the at least one input document and/or a knowledge database stored in a memory accessible to the computer;
e) generating, by the computer, a label association score for each skill label; and
f) generating, by the computer, a skills graph, wherein the skills graph optionally comprises at least 10,000 nodes and/or weighted edges, by
defining a skill topic node for each skill topic;
defining a skill label node for each skill label;
defining a weighted edge between each pair of skill topics, wherein the weight of the edge corresponds to the skill relation score; and
defining a weighted edge between each pair of skill topic and skill label, wherein the weight of the edge corresponds to the label association score.

2. The computer-implemented method of claim 1, wherein the input document is a textual data source and step a) comprises
i) analyzing a grammatical structure of the input document; and/or
ii) extracting words, optionally nouns and/or verbs, and/or sequences of words, from the input document to generate the list of candidate skill topics.

3. The computer-implemented method of claim 1, further comprising the following step between steps a) and b):
filtering the list of candidate skill topics, wherein the filtering comprises matching each candidate skill topic against a knowledge database, optionally wherein the knowledge database comprises a public encyclopedia.

4. The computer-implemented method of claim 1, wherein step b) comprises the following steps:
i) classifying, each candidate skill topic into one of a plurality of classes, comprising at least one skill-class and at least one non-skill class, optionally wherein the classifying is performed by a large language model; and
ii) removing each candidate skill topic that is classified into a non-skill class from the list of candidate skill topics.

5. The computer-implemented method of claim 1, further comprising the following steps between steps b) and c):
i) identifying synonymous skill topics, optionally by checking whether a pair of skill topics relates to the same document of a knowledge database; and
ii) for each skill topic, remove corresponding synonymous skill topics from the list of skill topics.

6. The computer-implemented method of claim 1, wherein step c) comprises the following steps:
i) generating a vector representation in a high-dimensional vector space for each skill topic; and
ii) computing a metric in the vector space based on context information associated with each pair of skill topics;
wherein the skill relation score is generated based on the value of the metric for the pair of skill topics.

7. The computer-implemented method of claim 1, wherein step d) comprises at least one of the following:
i) extracting phrases from the at least one input document;
ii) manipulating phrases extracted from the input document, optionally by removing prefixes and/or suffixes; and/or
iii) generating or extracting an abbreviation corresponding to a skill topic, optionally using a knowledge database.

8. The computer-implemented method of claim 1, wherein step e) comprises:
associating a probability distribution to the skill label, wherein the probability distribution is defined over all skill topics associated with the skill label and may be obtained from a knowledge database, optionally wherein the knowledge database comprises a public encyclopedia; and
the label association score is calculated by the marginal probability of the skill label over the probability distribution of the skill label.

9. The computer-implemented method of claim 1, further comprising the following steps after step f):
i) removing edges from the skills graph whose weight is less than a threshold value; and/or
ii) removing isolated nodes, optionally skill label nodes, from the skills graph.

10. A computer-implemented method for building a skill profile of an entity, optionally wherein the entity comprises a user, a job role, a job posting, a project, a work assignment, or a training, wherein the method comprises:
a) processing, by a computer, at least one input document to generate a plurality of phrases, wherein the at least one input document contains information about the entity;
b) generating a skills graph, by the computer, optionally wherein the skills graph comprises at least 10,000 nodes and/or weighted edges;
c) matching, by the computer, at least some of the phrases to one or more skill labels from the skills graph;
d) for each skill label that is matched to a phrase, identifying at least one skill topic in the skills graph, optionally based on the label association score, and adding the skill topic to the skill profile of the entity; and
e) generating, by the computer, a relevance score for each skill topic in the skill profile based on the at least one input document.

11. The computer-implemented method of claim 10, wherein step a) comprises at least one of the following:
a) extracting phrases, optionally nouns and/or verbs, from the at least one input document; and/or
b) applying a classification procedure on the extracted phrases for classifying the phrases into one of a plurality of classes, comprising at least one skill-class and at least one non-skill class.

12. The computer-implemented method of claim 11, wherein step c) comprises applying an algorithm for fuzzy string matching.

13. The computer-implemented method of claim 10, wherein in step e), the relevance score for each skill topic is computed based on at least one of the following:
i) number of occurrences of the corresponding phrase in the at least one input document;
ii) a position of the corresponding phrase in the at least one input document; and/or
iii) a skill relation score of a second skill topic identified in the at least one input document.

14. The computer-implemented method of claim 10, wherein the method further comprises:
loading a template associated with the at least one input document, wherein the template defines a section weight for each section of the at least one input document; and
wherein in step e), the relevance score for each skill topic is generated further based on the section weight of the section that comprises the phrase corresponding to the skill topic.

15. The computer-implemented method of claim 14, wherein the method further comprises:
assigning each skill topic from the skill profile to one of multiple levels according to the relevance score associated with the skill topic.

16. The computer-implemented method of claim 10, wherein the method comprises further:
i) receiving a user input specifying at least one level for a skill topic; and
ii) updating the assignment of skill topics to levels according to the user input.

17. A computer-implemented method for determining at least one target entity for a source entity, comprising:
a) generating a skills graph, wherein the skills graph optionally comprises at least 10,000 nodes and/or weighted edges;
b) generating a skill profile of the source entity;
c) generating a skill profile for at least one target entity candidate;
d) for each source skill from the skill profile of the source entity:
i) performing an iterated neighborhood search in the skills graph, starting from the source skill, until at least one target skill is identified, wherein a target skill is a skill topic associated with the skill profile of a target entity candidate; and
ii) generating a weighted score for the at least one target skill;
e) generating a total relevance score for each target entity candidate, based on relevance scores of skill topics from the skill profile of the target entity candidate; and
f) providing a recommendation list comprising each target entity candidate together with its total relevance score.

18. The computer-implemented method of claim 17, wherein the weighted score for the at least one target skill is a linear combination of at least one of the following:
a weight of the source skill according to the skill profile of the source entity;
a weight of the target skill according to the skill profile of the target entity candidate; and/or
the skill relation scores of any pair of skill topics that is adjacent in the skills graph and is located on a path between the source skill and the target skill;
wherein the weight of the source skill depends on a level of the source skill and on the relevance score of the source skill in the skill profile of the source entity, and
the weight of the target skill depends on a level of the target skill and on the relevance score of the target skill in the skill profile of the target entity.

19. The computer-implemented method of claim 18, wherein the iterated neighborhood search follows a breadth-first-search principle.

20. The computer-implemented method of claim 17, wherein the iterated neighborhood search is performed until a predetermined number of different target entity candidates are covered.

21. The computer-implemented method of claim 17, wherein the method further comprises:
receiving user input comprising instructions for adapting the recommendation list, optionally wherein the user input comprises a set of target entities to be deleted and/or an updated order of target entities; and
adapting the recommendation list according to the user input.

22. The computer-implemented method of claim 17, wherein the method comprises further:
receiving user input indicative of a favorites list comprising target entities from the recommendation list; and
storing the favorites list in a user profile.

23. A computer-implemented method for determining gap skills for a source entity with respect to a target entity, wherein the method comprises:
a) generating a skills graph according to the method of claim 1;
b) generating respective skill profiles of the source entity and the target entity;
c) determining a list of gap skills, based on a difference between the skill profile of the target entity and the skill profile of the source entity;
d) for each gap skill from the list of gap skills,
i) checking whether there exists a proxy skill topic in the skill profile of the source entity such that a relation score of the gap skill and the proxy skill topic exceeds a threshold value, and
ii) removing the gap skill from the list of gap skills if the proxy skill topic exists; and
e) providing the list of gap skills, wherein the list of gap skills is provided in a sorted order in accordance with levels of the corresponding skill topics in the skill profile of the target entity.

24. The computer-implemented method of claim 23, further comprising the following steps:
i) identifying at least one training based on the list of gap skills; and
ii) providing a list of trainings to a user, the list comprising the at least one identified training, in a sorted order;
wherein the sorted order is sorted in accordance with levels of the corresponding skill topics in the skill profile of the target entity.

25. A computer-implemented method for mapping organizational competencies, wherein the method comprises the following steps:
a) generating a skills graph according to the method of claim 1;
b) processing at least one input list of competencies associated with an organization, optionally by processing at least one job description associated with the organization;
c) for each competency, identifying associated skill topics from the skills graph to generate a competency model; and
d) for each competency and one or more source entities, determining a competency gap based on the competency model and corresponding skill profiles of the one or more source entities, optionally wherein each source entity comprises a person, a job, project, or a work assignment.

26. The computer-implemented method of claim 25, wherein step d) comprises:
determining one or more gap skills for the one or more source entities with respect to the competency model as a target entity;
wherein the competency gap includes at least some of the determined gap skills.

27. The computer-implemented method of claim 26, further comprising:
identifying at least one training or a series of trainings, based on the one or more gap skills.

28. A computer-implemented method for generating descriptions for an entity, optionally wherein the entity comprises an organizational job role, a job posting, a project, or a work assignment, wherein the method comprises:
a) generating a skills graph according to the method of claim 1;
b) training and/or fine-tuning a language model, optionally a large language model, using textual data descriptive of skills, job roles, job postings and/or projects;
c) receiving, as a user input, a title for the entity;
d) receiving, as a user input, a list of skill topics from the skills graph;
e) applying the language model on the title for generating a description, optionally in natural language, about the entity; and
f) generating a list of responsibilities and activities for the entity by using template queries on the language model, the template queries comprising the title and the list of skill topics.
